(19) United States
(12) Patent Application Publication
(10) Pub. No.: US 2013/0346265 A1
(43) Pub. Date: Dec. 26, 2013

(54) PATENT GUARD TOOL

(71) Applicant: BLACK HILLS IP HOLDINGS, LLC, MINNEAPOLIS, MN (US)

(72) Inventor: Steven W. Lundberg, Edina, MN (US)

(73) Assignee: BLACK HILLS IP HOLDINGS, LLC, MINNEAPOLIS, MN (US)

(21) Appl. No.: 14/010,391

(22) Filed: Aug. 26, 2013

Related U.S. Application Data
(63) Continuation of application No. 13/573,804, filed on Oct. 3, 2012.
(60) Provisional application No. 61/691,182, filed on Aug. 20, 2012.
(60) Provisional application No. 61/561,502, filed on Nov. 18, 2011.
(60) Provisional application No. 61/542,515, filed on Oct. 3, 2011.

(51) Int. Cl. G06Q 40/06; G06Q 50/18

(52) U.S. Cl. CPC G06Q 40/06; G06Q 50/184
USPC 705/30; 705/36 R

(57) ABSTRACT

Systems and methods for the enhanced use of patent protection monitors in patent portfolio management are proposed. In one example embodiment, a method includes providing, via a website or other communication portal, a patent monitoring tool including at least one interactive user interface. A user identifies a patent for automated monitoring at a patent office. A user can select engagement of an automated advisory monitors for the identified patent. The automated monitors may include a no-assignment-filed monitor, an assignment-changed monitor, and a patent-fee monitor. The patent-fee monitor may automatically initiate a patent revival process in the event a patent fee is not paid.

### CLAIMS OF PRIORITY AND CROSS-REFERENCE TO RELATED APPLICATIONS

This application is a continuation of U.S. application Ser. No. 13/573,804, entitled “Systems and Methods for Patent Portfolio Management” to Lundberg et al filed Oct. 3, 2012 (Attorney Docket No. 3431.002US1), which application is incorporated herein in its entirety.

U.S. application Ser. No. 13/573,804 also claims the benefit of priority, under 35 U.S.C. Section 119(e), to Lundberg et al, U.S. Provisional Patent Application Ser. No. 61/691,182, entitled “System And Method For Patent Portfolio Management” filed on Aug. 20, 2012 (Attorney Docket No. 3431.033PRV), which is hereby incorporated by reference herein in its entirety.

U.S. application Ser. No. 13/573,804 also claims the benefit of priority, under 35 U.S.C. Section 119(e), to Lundberg et al, U.S. Provisional Patent Application Ser. No. 61/561,502, entitled “Systems, Methods And User Interfaces In A Patent Management System” filed on Nov. 18, 2011 (Attorney Docket No. 3431.009PRV), which is hereby incorporated by reference herein in its entirety.

U.S. application Ser. No. 13/573,804 claims the benefit of priority, under 35 U.S.C. Section 119(e), to Lundberg et al, U.S. Provisional Patent Application Ser. No. 61/542,515, entitled “System and Method for Patent Portfolio Management” filed on Oct. 3, 2011 (Attorney Docket No. 3431.002PRV), which is hereby incorporated by reference herein in its entirety.

### BACKGROUND

The management of a patent portfolio involves multiple stages. Initially, a decision is made as to what inventions are worth the investment of filing a patent application. Then, each filed patent application goes through prosecution with the patent office. Finally, for each patent that is allowed, maintenance fees must be paid at a variety of intervals to keep the patent in force.

### BRIEF DESCRIPTION OF DRAWINGS

Some embodiments are illustrated by way of example and not limitation in the figures of the accompanying drawings in which:

FIG. 1 is a system component diagram, according to an example embodiment.

FIG. 2 is a block diagram of a patent management system, according to an example embodiment.

FIG. 3 is a user interface, according to an example embodiment.

FIG. 4 is a block diagram of machine in the example form of a computer system within which a set instructions, for causing the machine to perform any one or more of the methodologies discussed herein, may be executed.

FIGS. 5-8 show aspects of methods according to example embodiments.

### DETAILED DESCRIPTION

The life cycle of a patent may include multiple stages. These stages generally include invention, filing a patent application on the invention, prosecuting the patenting application to allowance or abandonment, determining whether to file any continuing applications, and paying maintenance fees on the allowed patent.

At each stage, one or more parties determine the best course of action to take with respect to the invention. For example, when determining whether or not to file a patent, the inventor may know what products are out in the technology area of the invention, a business manager may know how the invention fits in with a company's goals, and a patent attorney may have researched existing patents or application in the technology area of the patent. These parties will ultimately make the decision whether it is worth the initial investment of filing an application on the invention and then at each future stage determine the next course of action.

In various embodiments, a patent management system includes tools to help the parties involved in the patenting process make decisions at each stage of a patent's life. These tools may also be used for general research by parties not immediately involved with the patenting of the invention. Additionally, these tools may be used as standalone tools, in combination with other tools, and in combination with other patent management systems. Examples of tools include, but are not limited to prosecution analytics, reference management, prior art analytics, docketing management, claim mapping, claim analytics, portfolio analytics, annuity management, market analysis, user interfaces, and strategic monitoring.

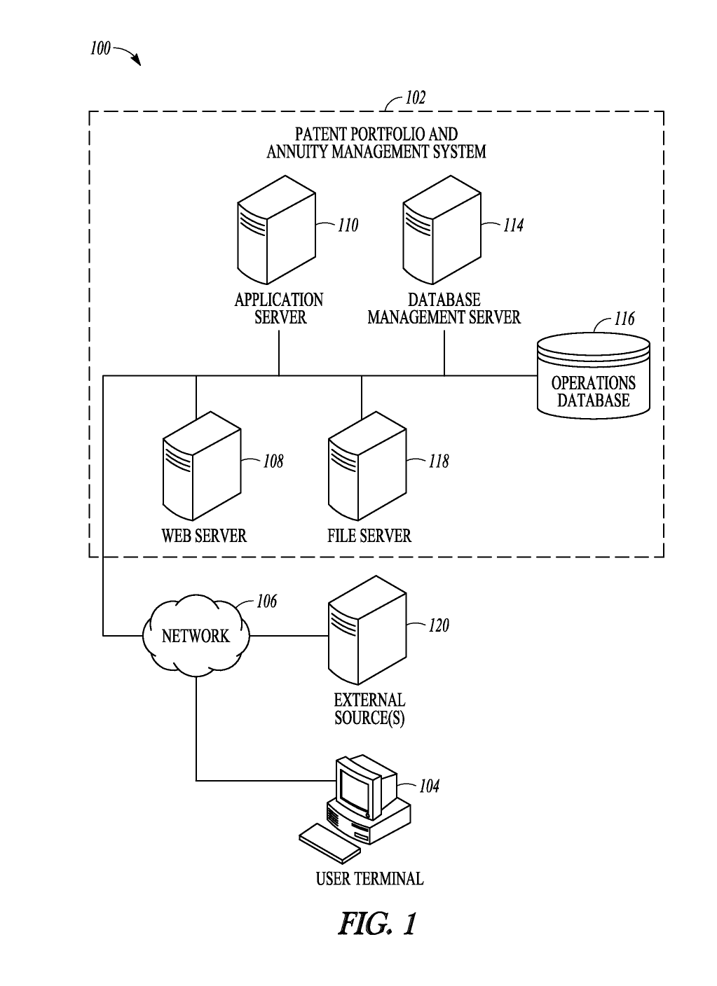

FIG. 1 is a schematic view of computer network system 100 according to various embodiments. The computer network system 100 includes patent management system 102 and user terminal 104 communicatively coupled via network 106. In an embodiment, patent management system 102 includes web server 108, application server 110, database management server 114, which may be used to manage at least operations database 116 and file server 118. Patent management system 102 may be implemented as a distributed system, for example one or more elements of the patent management system 102 may be located across a wide-area network from other elements of patent management system 102. As another example, a server (e.g., web server 108, file server 118, database management server 114) may represent a group of two or more servers, cooperating with each other, provided by way of a pooled, distributed, or redundant computing model.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LAN's or WAN's, such as the Internet. The various devices/systems coupled to network 106 may be coupled to network 106 via one or more wired or wireless connections.

Web server 108 may communicate with file server 118 to publish or serve files stored on file server 118. Web server 108 may also communicate or interface with the application server 110 to enable web-based applications and presentation of information. For example, application server 110 may consist of scripts, applications, or library files that provide primary or auxiliary functionality to web server 108 (e.g., multimedia, file transfer, or dynamic interface functions). Applications may include code, which when executed by one or more processors, run the tools of patent management system 102. In addition, application server 110 may also provide some or the entire interface for web server 108 to communicate with one or more of the other servers in patent management system 102 (e.g., database management server 114).

Web server 108, either alone or in conjunction with one or more other computers in patent management system 102, may provide a user-interface to user terminal 104 for interacting with the tools of patent management system 102 stored in application server 110. The user-interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™).

User terminal 104 may be a personal computer or mobile device. In an embodiment, user terminal 104 includes a client program to interface with patent management system 102. The client program may include commercial software, custom software, open source software, freeware, shareware, or other types of software packages. In an embodiment, the client program includes a thin client designed to provide query and data manipulation tools for a user of user terminal 104. The client program may interact with a server program hosted by, for example, application server 110. Additionally, the client program may interface with database management server 114.

Operations database 116 may be composed of one or more logical or physical databases. For example, operations database 116 may be viewed as a system of databases that when viewed as a compilation, represent an “operations database.” Sub-databases in such a configuration may include a matter database a portfolio database, a user database, a mapping database and an analytics. In various embodiments, additional databases are utilized for one or more of the patent tools. Operations database 116 may be implemented as a relational database, a centralized database, a distributed database, an object oriented database, or a flat database in various embodiments.

In various embodiments, the tools of the patent management system share a common framework. The framework may have a base organization unit of a matter. In various embodiments, a matter is an issued patent or patent application that includes one or more patent claims. In an embodiment, a matter is generally identified by its patent number or publication number. Identification may mean either identification as it relates to a user of the patent management system or within the patent management system. Thus, a user may see a matter listed as its patent number while internally a database of the patent management system may identify it by a random number. One or more matters may be associated with prior art or cited references stored in a reference or prior art database.

One or more matters may be grouped together to form a portfolio. A matter may also be associated with one or more other matters in a family. A family member may be a priority matter, a continuing (e.g., continuation, divisional) matter, or foreign counter-part member. Family members may be determined according to a legal status database such as INPADOC.

Data stored in a first database may be associated with data in a second database through the use of common data fields. For example, consider entries in the matter database formatted as [Matter ID, Patent Number] and entries in the portfolio database formatted as [Portfolio ID, Matter ID]. In this manner, a portfolio entry in the portfolio database is associated with a matter in the matter database through the Matter ID data field. In various embodiments, a matter may be associated with more than one portfolio by creating multiple entries in the portfolio database, one for each portfolio the matter is associated with. In other embodiments, one or more patent reference documents may be associated with a patent by creating multiple entries in the patent database, for example. The structure of the database and format and data field titles are for illustration purposes and other structures, names, formats may be used. Additionally, further associations between data stored in the databases may be created as discussed further herein.

During operation of patent management system 102, data from multiple data sources (internal and external) is imported into or accessed by the operations database 116. Internal sources may include data from the various tools of the patent management system. External sources 120 may include websites or databases associated with foreign and domestic patent offices, assignment databases, WIPO, INPADOC, and law firm databases. In various embodiments, the data is scraped and parsed from the websites if it is unavailable through a database. The data may be gathered using API calls to the sources when available. The data may be imported and stored in the operations database on a scheduled basis, such as weekly, monthly, quarterly, or some other regular or periodic interval. Alternatively, the data may be imported on-demand.

After data importation, the data may be standardized into a common format. For example, database records from internal or external sources may not be in a compatible format with the operations database. Data conditioning may include data rearrangement, normalization, filtering (e.g., removing duplicates), sorting, binning, or other operations to transform the data into a common format (e.g., using similar date formats and name formats).

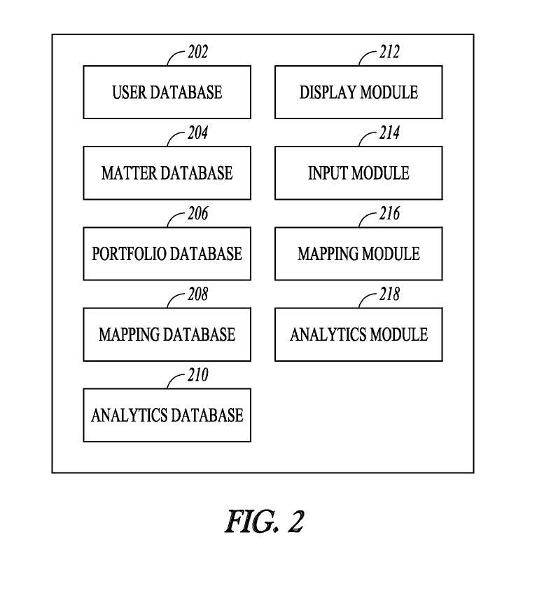

FIG. 2 is a block diagram of patent management system 102, according to an example embodiment. Illustrated are user database 202, matter database 204, portfolio database 206, mapping database 208, analytics database 210, display module 212, input module 214, mapping module 216, and analytics module 218. Additional or fewer modules may be utilized in implementing functionality of one or more of the patent tools. In various embodiments, the data stored in databases 202, 204, 206, 208, and 210 may be in the same or multiple physical locations. For example, portfolio database 206 may be stored in one or more computers associated with a portfolio management service. In various embodiments, patent management system 102 mirrors databases stored in other locations. In an embodiment, when a request is made to access data stored in the databases, patent management system 102 determines where the data is located and directs the request to the appropriate location. Similarly, modules 212-218 may be executed across multiple computer systems.

In an example embodiment user database 202 stores data representing users of patent management system 102. The data may include data fields of user credentials including a user ID and password and access rights with respect to patent management system 102. The user ID may be a common across the tools of the patent management system. In this manner, access rights of the user with respect to the tools of the patent management system may follow across the various tools of the patent management system. In an example embodiment, different access rights are granted to a user ID between the various tools.

In various embodiments, each user ID has access rights to one or matters. Similarly, a user ID may have portfolio level access rights. Access rights may be defined according to at least two parameters: read access and write access. Thus, when a user logs into patent management system 102, the user is presented with access only to the matters/portfolios that have been associated with the user ID. More (e.g., additional contact information) or fewer data fields associated with a user may be included in a user entry stored in user database 202.

In an embodiment, matter database 204 stores data representing matters. Each matter may be associated with one or more portfolios as well. In some embodiments, a matter is associated with no portfolios. In various embodiments, a matter is a foreign or domestic patent or application. Matters may also be inventions that have not yet been filed (e.g., as may be the case within a docketing system). In an embodiment, a matter entry includes data fields representing a matter ID, patent number, publication number, serial number, docketing number, title (e.g., the name of the patent or application), type of the matter (e.g., application, issued patent, PCT application), status of the matter (e.g., issued, abandoned, allowed), a link to the patent office where the matter was filed, a link to a PDF download of the matter, abstract of the matter, inventors of the matter, current owner of the matter, cited references on the face of the matter, filed date, issue date, docket number, and annuity information (e.g., due date, country, and amount due). In some embodiments, other patent reference documents or prior art in any form may be stored and associated with one or more matters. More or fewer data fields associated with a patent may be included in a matter entry stored in matter database 204. In an example embodiment, matter database 204 may store a patent matter database, wherein this database includes data about the patent matters. The data may include for at least one patent matter a claim set or statement of invention and a priority date for the claim set or statement of invention. Matter database 204 may also store a database of prior art documents (also known as “references”), wherein the prior art database includes data about the prior art documents. The data may include for at least one prior art document a priority date or publication date of the document. One or more of the prior art documents may be associated with a first patent matter in the patent matter database.

In various embodiments, a matter is associated with one or more other matters as a family with a family ID. Family members may be priority documents, continuation patents/applications, divisional patents/applications, and foreign patent/application counterparts. In an embodiment, family information is determined according to an external source such as INPADOC. Patent reference documents and/or other prior art may be manually or automatically stored, cross-cited and associated with related family matters, for example.

Portfolio database 206, in an example embodiment, stores data representing portfolios of one or more matters. Data stored in portfolio database 206 may have been previously generated by a tool of patent management system 102. In various embodiments, a portfolio may be generated by a user using patent management 102. For example, a user interface may be presented to the user requesting a name for the portfolio and identifiers of matters to be included in the portfolio. In an embodiment, a portfolio entry in portfolio database 206 includes data fields of portfolio ID and portfolio name. Additionally, a data field for matter ID may also be included in an entry in the portfolio database. Thus, each portfolio may be associated with one or more matters through the use of the matter ID data field. More or fewer data fields associated with a portfolio may be included in a portfolio entry of portfolio database 206.

In an example embodiment, mapping database 208 includes mappings of scope concepts, technology categories, and keywords to one or more matters. In an embodiment, a scope concept is a textual description of what a patent claim is at least limited to. Thus, if a claim comprises A, B, & C a scope concept may be A. In various embodiments, a scope concept for the claim may be broader than A because the claim will still be limited to the broader scope concept. In an embodiment, the mapping database stores mappings between claims and scope concepts. A technology category mapping may indicate a claim is in a certain technology area. A keyword mapping indicates may indicate that there is an exact match between the keyword and a subset of the claim language.

In various embodiments, analytics database 210 stores data representing calculated analytics on data stored within patent management system 102 or external data sources. In various embodiments, analytics are organized according to an individual matter, a portfolio, or family. The calculated analytics may be based on information gathered from multiple sources such as databases of patent management system 102 and PAIR.

In various embodiments, information for an individual matter may include status (e.g., disclosure received, drafting, filed, completed-waiting examination, in prosecution, allowed, issued), cited prior art, list and type of rejections (e.g., 35 U.S.C. §101, 102, 103) number of claims allowed, office action count, interviews held, IDS statements filed, attorney fees to date, and PTO fees to date. Further metrics for an individual matter stored in analytics database 210 may include, time waiting for examiner, total time in examination, time waiting for PTO while in examination, time on appeal. Additional prosecution details formatter may include an upcoming docket dates (e.g., due dates for office action, IDS due dates, etc.). A claim prosecution history chart may also be stored in analytics database 210 for each matter. The prosecution history may include a history of claim amendments and arguments made in prosecution.

In various embodiments, portfolio and family analytics information may be stored in analytics database 210 based on aggregating the metrics for an individual matter. In an embodiment, the analytics of a family may differ from those in a portfolio as not all family member matters may be part of a portfolio. Additionally, the analytics may be stored for multiple time periods such that comparisons may be made between metrics currently and metrics a year ago (or other time period).

Aggregated metrics may include a total patents and applications, pending and waiting for examination, in prosecution with no claims allowed, in prosecution with some claims allowed, appealed, notice of allowance received, and issued. These metrics may be compiled for both US and international matters in the portfolio. Additional information may include the international portfolio distribution by country. An age distribution of the portfolio may also be compiled. For example the portfolio may be broken down by less than one year old, 1 to 3 years old, 3 to 5 years old, 5 to 10 years old, 10 to 20 years old, and 20 or more years old. Recent filing and issue activity as well as upcoming Ford filing deadlines may be stored in analytics database 210.

In various embodiments, prosecution metrics across a portfolio or family are determined and stored in analytics database 210. This data may include matters waiting for examination, matters in examination, matters appealed, and cases allowed but not yet issued. Analytics with respect office actions may also be compiled and stored. For example success of allowance after a first office action response, a second response, etc., may be stored in analytics database 210. Additional prosecution analytics may include allowance rate (e.g., 10%) after a telephone interview, allowance after an in-person interview, percentage of interviews with response, number and type of rejection, average time in prosecution (e.g., in months), average time to file a response, and average time to next office action. Further, the list of recently allowed cases, recently appeal cases, stalled cases, and recently abandoned cases may also be stored for each portfolio and family in analytics database 210.

In various embodiments, the results of keyword analysis on one or more matters and/or prior art references may be stored in analytics database 210. The keyword analysis may be based on the occurrences of the keywords in the matter or references to derive a score or keyword overlap.

In various embodiments, data stored in the database for group of matters in a portfolio or family is analyzed to determine the top (e.g., ten) most cited patents, the top most cited inventors, top most cited prior art owners (e.g., according to assignment documents or the face of the patent), newly (e.g., within the last 60 days) cited prior art owners, and top most cited prior art inventors. This information may be stored in analytics database 210.

In an embodiment, display module 212 is configured to display user interfaces and information retrieved from one or more databases 202-210. If a user is accessing patent management system 102 remotely (e.g., through a web browser) display module 212 may be configured to transmit data representing a user-interface through a network to a user terminal. In various embodiments, display module 212 is configured to generate one or more charts of data stored in databases 202-210. For example, display module 212 may generate a pie chart of the top 10 inventors within a portfolio.

In various embodiments, input module 214 receives data from multiple sources where it may be further processed by one or more other modules and stored in one or more of databases 202-210. For example, input module 214 may be configured to utilize one or more APIs to data from one or more patent data stores (e.g., public PAIR, private PAIR, INPADOC, foreign patent offices, patent docketing systems, portfolio management systems, etc). The data may include published patent documents, patent applications, office actions or other patent office correspondence, prior art references, claim mappings, dockets dates, and annuity payment data.

In various embodiments, input module 214 is configured to receive input from one or more user interface elements. For example patent management system 102 may present multiple user interfaces to a user. These user interfaces may enable users to input data directly into databases 202-210, instruct the patent management system to retrieve data from patent data stores, and instruct the patent management system to perform various operations (e.g., analysis) on the data in databases 202-210.

Additionally, input module 214 may be configured to determine the selection of one or more user interface elements by a user and initiate the action associated with the selected user interface element. For example, a user interface element may include a drop-down menu to select a portfolio. Input module 214 may be configured to receive the selection of the portfolio by the user. Then, input module 214 may pass the selection to one or more other modules for further processing. For example, display module 214 may update the drop-down menu to indicate the selection of the portfolio.

In various embodiments, input module 214 processes the data that has been inputted and formats it according to the data fields of databases 202-210 as discussed above. Is various embodiment processing is completed using a parsing module (not shown). For example, consider a patent publication that a user has directed to be inputted into one or more of the databases. The processing module may use a combination of automatic image recognition and text analysis to determine the filing date, issue date, title, abstract, and claims of the patent. In some embodiments, the parsing module may flag certain pieces of data that had been determined to be potentially inaccurate (e.g., a number could not be read). A user of patent management system 102 may then examine the flagged data and manually enter the information which is then stored in the appropriate database.

The resulting data that has been parsed by the parsing module may then be entered as an entry in one or more of databases 202-210. This may be accomplished by, for example, formulating an insert SQL query with the parsed information. In various embodiments the parsing module may parse multiple piece of information before generating a database entry. For example, input module 214 may receive a docket number for an issued patent. The docket number may be combined with the information parses from the issued patent to form an entry in matter database 204.

In various embodiments, mapping module 216 is configured to facilitate mappings of scope concept, technology categories, and keywords to patent claims of a matter. In an embodiment, mapping signifies association. For example, in conjunction with display module 212 and input module 214, mapping module 216 may present a user interface of patent claims stored in matter database 204 and scope concepts stored in mapping database 208. Input module 214 may receive a selection of one or more patent claims and one or more scope concepts and pass them to mapping module 216. Mapping module 216 may then formulate an SQL query to associate the one or more patents claims with the one or more scope concepts. When executed, the SQL query, may update the mapping database 208 with the associations. In various embodiments, mapping module 216 also allows the creation of new scope concepts, technology categories, and keywords that may be mapped to one or more patent claims. Furthermore, mapping module may present user interfaces that allow a user to rank and rate matters stored in matter database 204.

Mapping module 216 may also allow the generation of claim charts of a plurality of cells. A claim chart may include one or more scope concepts, technology categories, and keywords on one axis and claims of matters in a portfolio on the other axis. The claim chart may include a variety of levels of granularity of scope concepts. Some claims may be mapped to all of the scope concepts while others may not be mapped to any scope concepts. At the cell intersection between a scope concept (or technology category or keyword) and a claim an indication of the mapping may be presented by changing the format of the cell. For example, the cell may be colored blue when a scope concept is mapped and red when not mapped.

In various embodiments, analytics module 218 is configured to examine and run calculations on the data stored in the databases 202-210 to generate the analytics discussed previously. For example, analytics module 218 may formulate an SQL query that retrieves the number of times that a prior art reference has been cited within a portfolio. This query may be run for each prior art cited within the portfolio to determine a list of the most cited (e.g., the top ten) prior art references with a portfolio. In an embodiment, the queries are formulated and run as requested by a user. In an embodiment, once the analytics information has been determined, it is stored within analytics database 210. In various embodiments, queries are formulated and run on a periodic basis (e.g., nightly) and entries in analytics database 210 may be updated to reflect any changes.

In various embodiments, the analytics module 218 is configured to receive input identifying a pool of keywords for a first patent matter in matter database 206 and associated prior art documents in matter database 206. The term keyword is intended to include individual keywords as well as a number of keywords grouped together making up a key phrase, for example. The module 218 may be further configured to perform a keyword analysis on the first patent matter and associated prior art documents based on occurrences of the keywords in the first patent matter and associated prior art documents. The module 218 may be further configured to identify, based on the analysis, keywords occurring uniquely in the first patent matter. In view of their uniquely occurring nature, these keywords may be regarded as claim elements potentially differentiating the claim set or statement of invention over the disclosures contained in the one or more prior art documents.

In various embodiments, a filtering module is configured to filter a set of matters according to a user preference. For example, a user may activate a check box that indicates only pending matters should be shown in a user interface. The filtering module may formulate a query consistent with retrieving only pending matters. The results of the query may then be shared with display module 212 where the user interface may be updated.

In various embodiments, a payment module is configured to receive selections by the user of which annuities to pay for matters in a portfolio. Additionally, the payment module may receive user preferences related to the payment of the annuities. The payment module may receive payment information from a user and forward the payment information to the appropriate agency/office. In some embodiments, annuity management system 102 organizes payment of the annuity on behalf of the user and the user pays annuity management system 102.

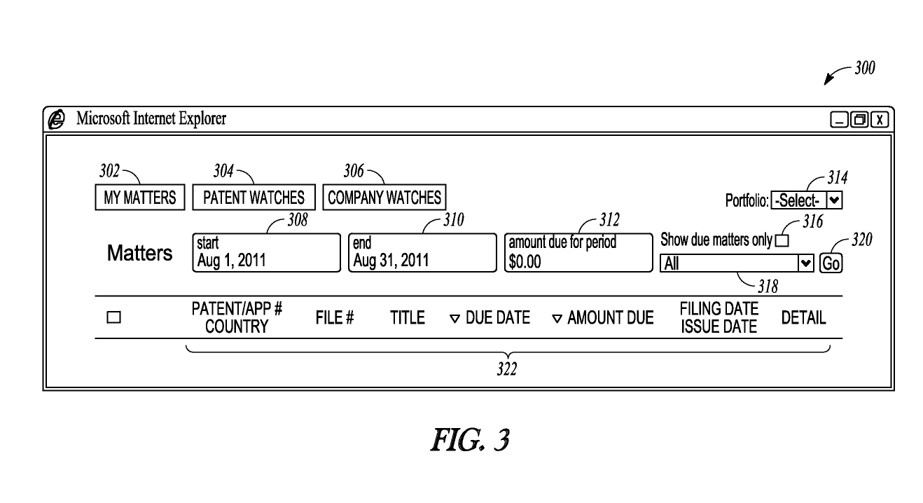

FIG. 3 is an example user interface 300 of patent management system 102 which may be used to facilitate the methods, tools and systems described herein. User interface 300 is illustrated with multiple user interface elements. In an example embodiment, a user interface element is a graphical or textual element that a user may interact with to cause an application to perform an assigned action for the interface element. Data representing user interface 300 may be transmitted via network 106 and presented on a display of user terminal 104 through the use of a web browser. A user (e.g., manager of a patent portfolio) may interact with the user interface elements of user interface 300 through the use of an input device (e.g., stylus, cursor, mouse, finger) of the user terminal. In an embodiment, a user selection is based on the coordinates of the input device as it makes contact with the display or where a user “clicks” the mouse. The coordinates are compared to the coordinates of the user input element to determine the selection. The type of user elements, names, and layout depicted in FIG. 3 are intended to be an illustration of an example user interface of patent management system 100. Other types of user elements, names, and layouts may be used.

The user interface elements may include my matters 302, patent watches 304, and company watches 306. These elements may be used to select a context/view of the patent management system. For example, my matters lists the patents included within a portfolio of a user, patent watches lists information on patents that the user has indicated the patent management system is to watch, and company watches lists information on companies that the user has indicated the system should watch. Further details of each of these included herein.

Date boxes 308 and 310 are user elements that allow a user to select a time period. Amount due box 312 displays the amount due with respect to annuities for patents in the portfolio of the user within the period indicated by date boxes 308 and 310. Upon activating (e.g., clicking) one of the date boxes, a user may be presented with a calendar which allows the selection of a date. Upon selecting a date, the date boxes will update to reflect the user's choice.

Drop-down menu 314 includes a list of portfolios that a user of the patent management system is authorized to view. For example, before user interface 300 is displayed, a login screen may be presented to the user which requests a user ID and password. In various embodiments, the user ID is associated with one or more portfolios. In turn, each portfolio is associated with one or more matters. Matters may include US and foreign issued patents, pending patents, abandoned patents, and not yet filed applications. Thus, upon selection of a portfolio using drop-down menu 314, user interface 300 is populated with matters associated with the portfolio.

Checkbox 316 is an option to only display matters that currently have an annuity due. Drop-down menu 318 allows further filtering of matters. For example the matters may be filtered by US patents only, US patent applications, and foreign only.

In various embodiments, activation of button 320 updates user interface 300 to reflect the choices made by the user with respect to date boxes 308 and 310, checkbox 316, and drop-down menu 318. For example, amount due box 312 will be updated to reflect the amount due within the new period and the matters listed under column headings 322 may be filtered. In various embodiments, user interface 300 is updated as the user selections are made with respect to elements 308 to 318 without activating button 320.

Prosecution Analytics

Various tools may be implemented using the system described above. Some of the tools are described below.

In various embodiments, a software tool to collect and present prosecution analytics may be used with patent management system 102. For example, a dashboard may be displayed for each matter in a user's portfolio to give specific information for the matter or overall portfolio metrics. For each matter the dashboard may include docket dates as well as analytics listed below.

In various embodiments, analytics including success rate(s) of responses based on the following:
a. Probability a response will result in allowance or other event;
   i. Responses of different types, e.g. non-final, final, after final;
   ii. Based on class/subclass;
   iii. Based on examiner;
   iv. Based on art unit;
   v. Based on number of prior responses;
   vi. Based on how long the case has been in active prosecution;
b. Analytics—success rates based on USPTO statistics or Attorney or Attorney Organization data;
   i. Probabilities of 2 for each—USPTO vs. Attorney vs. Attorney Org;
   ii. Compare both;
c. Analytics—success rates based on Owner of Patent/Invention;
d. Analytics—success rate based on type of owner—e.g., small or large entity;
e. Analytics—success rates based on Prior Art Owners;
f. Analytics—success rates based on length of claim;
g. Analytics—success rates based on number of words added to claim; h.
h. Analytics—success rates based on length of arguments;
i. Analytics—success rates based on type of rejection;
j. Analytics—success rates based on effective date of prior art; and
k. Analytics—success rate based on keyword/key phrase overlap between prior art and application specifications

In an embodiment, additional analytics are displayed to a user based on analytics in PAIR like system (sometimes referred to as PAIR Plus): statistics for examiner; supervisor; statistics for art unit; statistics for class/subclass; and analytics on the prior art.

In various embodiments, prosecution Analytics are generated from PAIR and combined with information in an existing file management (e.g., docketing) system. The analytics may be combined to generate portfolio prosecution Analytics. Success rates may be checked based on results (e.g., correlate to attorneys and examiners).

Reference Management

In various embodiments, tools for prior art management are used in patent management system 102. In an embodiment, in a matter management system (e.g., patent management system 102), there us a cross-citation control panel for citing prior art between cases. In various embodiments, the control panel:
i. shows all cases to “send” art to or “receive” art from or both;
ii. allows user to set rules for sending or receiving based on;
   a. Number of time art has hopped already to get to the matter;
   b. Type of citation—102(b)/103;
iii. Cases to send or receive from can be automatically populated by family matters or other matters.
   The tool may also show citations pathway for each reference:

a. Where it started;

b. What it flowed through;

In various embodiments, a prior management portfolio may be created by that has features of:

a. Loading Matters (pending or issued apps) into special “prior art management” portfolios;

b. Art automatically flow between Matters in a portfolio;

c. Art flows between portfolios via Matters listed in more than one portfolio;

d. Art is kept in list in Portfolio;

e. Not based on patent family or related cases necessarily—any arbitrary cases can be added;

f. Art displayed in each Matter can be filtered by:
i. Cross-cited art (art arriving from other Matters);
   1. Number of hops to get to list;
   2. Type of rejection (102/103);
   3. Other analytics—see e.g., prior art analytics;
   4. New art added to Portfolio;

g. Art can be added to Portfolio, in the Prior Art (called “references”) list;
i. This art is not cross cited to other Matters in other portfolios until it is added first to a Matter to be cited or as cited;
ii. This art is displayed for each Matter to be considered, as “new art” not yet cross-cited”

In various embodiments, PAIR Plus may include:

a. Pair data;

b. Uncited art cross-reference;

c. Links to cases beyond PAIR;

d. Scanned docs;

e. Art analysis;

f. Art highlights;

g. Analytics with Actions;

h. Foreign cases;

i. Docket Dates for Matter—calculated by PAIR PLUS;

j. PAIR Process Options—process options for any given point in a case

k. Foreign PAIR; a. Aggregate of US and foreign PAIR

In various embodiments, PAIR Plus may also automatically proof claims, scan amendments, assemble most recent claims, compare to issued patent, scan prior art, make a list of prior art, and compare it to the issued patent. Differences may be determined between the filed specification and issued specification. The differences may be presented to a user for review.

Prior Art Analytics

In various embodiments, a tool for analytics of prior Art includes:
a. Automatic keyword/key phrase differentiation;
   i. Create pool of keyword/key phrases for prior art and for pending application;
   ii. Note differentiating keyword/key phrases;
b. Automatic prior art ranking based on keyword/key phrase overlap;
   i. Art with most keyword/key phrase overlap is highest ranked;
   ii. Allow manual addition of synonyms to enhance analysis;
c. Prior art timeline graphs;
   i. Show timeline with dates of prior art vs. application;
   ii. Show timeline of all patents or applications in class/subclass, in comparison to pending application;
d. Keyword/key phrase timeline graphs;
   i. Show timeline of when keyword/key phrases of application first appeared in prior art;
   ii. Could be table/chart with keyword/key phrases listed by order of appearance by year, with representation of each year; and
e. Dominance of owners by keyword/key phrase—show which owners own most art with matching terminology (also for payment analytics).

In various embodiments, an analytics tool may be used to determine prior art overlap. For example, for example competitor overlap for single patent, portfolio, or family may be include:

a. prior art citation overlap;

b. overlap of prior art cited against Target Company's patent or portfolio, and prior art cited against Competitor Company or Companies, identified by user;

c. analytic result may include a list of prior art cited against both the Target and the Competitors;

d. analytic result may include list of companies that own prior art cited against Target and Competitors (e.g., show the number of references cited against both owned by Target).

In various embodiments, a process is used that: 1) looks at US patent and if it shows a reference was applied, get name of company it was cited against and highlight that company as a target for the applied reference; 2) for applied references, crawl PAIR and OCR or otherwise reverse engineer the reason reference was cited, and pull comments by PTO or attorney; and 3) take note if it was a §102 reference or §103. Then, In various embodiments, do the same for foreign references of PCT search. For example, determining if an applied reference was a 102/103 a tool may determine the name of the applied reference from the face of patent and then look for text “102” or “103” near the reference in the ocrd text, or like in foreigns.

An output may include a chart with headings of Prior Art Reference, # Cited against Target, and #Cited against Competitor 1, 2, 3 with example entries:

Reference A, [x], [y, z, a . . . ]

Reference B, [e], [b, c, d]

In various embodiments, a tool is used for prior art and forward reference citation analysis. The tool may generate a continuing stream of “watch results” for a single patent (or a group of patents). In an embodiment, there is a problem if an inventor or company sets up a watch to see if their patent is being cited by later-issued patents, many times no such cites occur for a long time, if at all. The tool helps produce a steady stream of watch results, on a daily/weekly/monthly basis. The tool may for: a. Forward cites of prior art: i. take the pool of all prior art cited on patent; ii. watch for forward cites of any of this art; iii. report these forward cites; b. Forward cites of applied prior art only: i. take pool of applied art cited on patent (USPTO puts asterisk on these); ii. watch for forward cites; iii. report these forward cites; c. Forward cites of patent being watched; i. this is prior art; d. Forward cites of forward cites; i. here we look at the forward cites of patent being watched; ii. report any forward cites of those references; e. forward cites of forward cites of prior art. In various embodiments, the display of these results can be dynamically determined based on the number of results available by: a. for example, may want to suppress presentation of more remotely relevant watch results if there are plenty of more pertinent watch results; b. or, list results in order of perceived pertinence; i. forward cites of watched patent of course most relevant; ii. perhaps forward cites of applied art next most relevant; iii. then, perhaps, forward cites of forward cites; iv. then, perhaps, forward cites of any prior art reference; F) Also, the tool can filter watch results from the company that owns the patent—so if the owner of the watched patent cites back to it, the tool may provided an option to ignore those results.

In various embodiments, a prior art date analyzer is used to: a) In PAIR, using patent number, pull priority dates from PAIR or other source for US patent/application; and b) apply prior art rules to determine likely effective date of reference.

Docketing Management

In various embodiments, the PAIR Plus tool may include a docket verification-docket built in. For example: a) PAIR or portions thereof may be scraped or copied; b) in particular, transaction log or log of office actions; c) a docket engine that may be part of the tool; d) the docket engine may determine a set of docket dates—response due dates etc., e) due dates may also be for foreign filing or prior art cross citation; f) those dates are associated with or embedded into a PAIR document; g) user may download the PAIR document and the due dates are either on a PDF or on an Excel or XML or other form with document; h) or, user can synchronize their Outlook calendar with PAIR due dates; i) If the tool does not know the date, the tool may flag that and add to calendar or list of exceptions as an exception that needs to be looked at; j) or, there may be a PAIR docket system that users may subscribe to and get a docket that is driven directly off of PAIR—(e.g., the tool can check things off as done once filed in PAIR); ii. and the tool can docket a date that is not a response date (e.g., foreign filing or as noted above, IDS cross cites); k) the PAIR docket can also check other related matters, and docket for prior art cross-citation if system sees references cited in related case.

In various embodiments, to obtain some of the data above the tool may scrape or download PTO actions from foreign patent offices (either selectively or in bulk), OCR to get electronic data or reformat electronic other data downloaded, provide that electronic data to a user/operator of a docket system, and provide an import mechanism for the docket system, either as a BOT or through an API, to load docket information.

In various embodiments, another tool of PAIR plus may include automatically OCR of all PAIR docs and provide word or PDF text doc versions of PTO docs to PAIR plus user and/or using automatic text analysis, the tool may extract details/types of PTO actions as well as references. This then is added to the data set for the patent, and delivered in PAIR plus. In an embodiment, PAIR plus looks similar to the traditional USPTO site but with extra metadata.

In various embodiment, a tool is used to verify the accuracy of information for transferred in files as well as automating some of the entry of information for those files. For example the tool may search for an owner's name in international data, then picking additional matters to open from there, and automating the file entry. For example, the file type could be determined (e.g., PRV, ORG—which may or may not actually claim priority to another country—EPPAT, Non-PRV, CON/DIV. The tool may select the file type and automate the data entry after that. For example, the tool could also scan paperwork and OCR to extract key identifying information. The tool may get owner's name, pull a report from public PTO data that shows all of that owners files, and then have a user pick the file that matches the one they are opening. Additional data verification may include serial numbers and priority and filing dates from international patent databases, or US databases for US cases, in order to verify or even semi-automate entry of data for matter openings.

In various embodiments, a tool is used to set up goals and display progress towards those goals for a given period (e.g., quarter, year). The goals may include, number of new patent applications, number to issue, number of disclosures and, and number of defensive publications. The goals may also be separated out by country. A dashboard interface may display the goal and the current status (e.g., how m any patent applications have been filed). The interface may also include how many patent applications (or other goal metric) need to be filed per day/week in order to achieve the goals.

In various embodiments, a docketing management system may be improved in the following manner: 1) in the activity view, include a link that launches a calendar view of all milestone dates, with final dates highlighted, for example yellow for 5 months response date and red on 6 month response dates it red on foreign filing dates; 2) one of the above can be displayed for all activities or just one; 3) calendar can either be a monthly calendar with each day represented as a square, or monthly, with each month as a square but no daily detail, or yearly; 4) the other display mode may be a timeline mode; 5) for the timeline mode, each activity (process) can be represented as an individual horizontal line that has milestones and due dates for milestones and the corresponding dates of each horizontal line can be vertically aligned; 6) each activity/process can have a cost associated with it and the cost may be dependent on choices to be made for the process, like foreign filing, there can be a wizard that might for example launch process timelines for each contemplated foreign filing and the costs associated therewith; 7) projected costs for all processes are totaled on timeline to show timing of costs in the aggregate.

In an example implementation activity tasks/due dates are read and translated to Timeline format, and aligned in a timeline view of the case processes. Cost data for each activity can be kept and read to supply budget information. Activities may also be tagged as optional or essential, and if optional their costs could be suppressed to see how total budget is affected.

In various embodiments, a visual process manager tool is implemented. It may include the following features: 1) Each Process (e.g., draft application, office action report, response, etc.) has a timeline (or calendar). Timeline is visual of process due dates and milestones; 2) each process has it's own Process Options or Decisions; 3) each process has a messaging area that attorneys/paralegals can post messages regarding the process. These messages can then be sent to client via one or more or all of media: e-mail, text, written letter, telephone call (recorded); 4) each process has messaging area that can store and retain key client messages or instructions, either in the form of a recorded telephone call or message, a saved e-mail, a saved text message, an image of a document; 5) process can require client verification of key processes by either: automated telephone call with dtmf of voice response; automated e-mail with reply or click through to page with verification options.

In various embodiments, for a process (e.g., foreign filing in and maintenance fee decisions), a process verification engine may obtain verification of key decisions from client and if no such verification is obtained, an alarm may be triggered. The process may include the following: 1) foreign filing paralegal obtains client instructions; 2) paralegal tells client they will be required to provide us verification. Verification may be obtained from a known/approved phone number or using an approved e-mail or fax or using some other authentication (at customer option perhaps); 3) client then, for example, gets telephone call to verify instructions that are recorded in the system (for example from a menu of options —“no filing”, file in PCT, file in (pick countries), or they receive an email and have to reply “confirmed” or click through. In an embodiment, the verification is offered as an option to one or more templates for a process. In another embodiment, this may be a separate key process verification engine that ran verification separate from a main docketing engine. In various embodiments, verification may require a bulk process.

In various embodiments, a tool of a docketing system may offer possible procedures available for an attorney or client for each activity. The possible procedures may be based on milestones and advantages/disadvantages for each procedure and cost.

In various embodiments, a docketing management tool may keep standardized instructions, or instructions customized for particular clients. These instructions can them be readily associated with processes or reporting procedures so they are consistently delivered to clients. For example, if a client views a dashboard or gets a report out email.

Claim Mapping

In various embodiments, a tool may run analytics on scope concepts or claim keyword Google Search using: a. Scope Concepts are fed into Google, or otherwise used to search Internet, to generate a list of search results; b. Differences in Search Results from one day to the next, or one week to the next, is displayed as “new results”; c. Search is done either on all Internet or is executed only to look for appearance of hits on specific competitors; d. new search results are shown each day or periodically; e. Same thing can be done as above, but instead of using scope concept, the tool takes the keywords from the claim and use those keywords (keywords from claims can either be just all non-routine words or can be determined by looking to see which keywords are unique compared to cited prior art); f. generate search results from web for informational purposes; and g. can use linguistic analysis to find matches.

In various embodiments, a tool may organize concepts within Panoramic Claim Charts. The process may include: a) meta-label sort to organize concepts under meta-labels; b) meta-labels are like Scope Concept groups; c) have Scope Concept groups that are added by mapper, and can organize map output by the groups; d) ability to direct/specify the order Scope Concepts are displayed, and be able to store for later reuse as well as be able to hide concepts too.

In various embodiments, concepts from independent claims may be applied to dependent claims by: a) rolling down of mapping from independent claims to dependent claims; b) Optional reporting on that—so show in panoramic map, make roll down optional, (i.e., treat independent claim limitations as if they were part of dependent claims, or not, optionally); c) relationship may be calculated on the fly.

In various embodiments a tool is used to determine a claim similarity and uses a claim similarity index to identify claims to map scope concepts to. The similarity of paragraph of claims or total claim may be measured by: a) keyword similarity—roots of words are compared after throwing out unimportant words; b) linguistic analysis—how similar based on other approaches. In one implementation, a mapping system may suggest to users mapping claims which claims are most similar to one another, or what parts of claims are most similar to one another. In another implementation, claims are just flagged as similar for later use. In an embodiment, claims are determined to be similar based on keyword similarity

In various embodiments a tool is used when mapping claims allowing a user to highlight the claim terms associated with a scope concept across a number of claims, storing those associations, and then when subsequently displaying those claims. For example, showing which claim terms have already been mapped (e.g., by highlighting those terms, perhaps in different colors for better visualization). This may be helpful in those cases where you move to another patent and have already mapped portions of claims. This would make it easier to see what you've mapped. In an embodiment the system automatically identifies common claim terms or elements and displays this so a user could map them more quickly. The user may define common claim terms or set a filter them based on unique words or phrases of a certain number of words.

In various embodiments a tool is used to aid in mapping claims to a product. For example, instead of using claim map, the tool show claims parsed by paragraph. Next to each paragraph, a user can indicate if the product includes the technology described in the claim.

In an embodiment, a tool is implemented for use in mapping and product analysis. The tool may: 1) grab Field of Invention and present with claim map; 2) grab claim segment or segments, maybe one or two per claim, that look to define point of novelty or at least help position scope of claim —optionally link to specification segment; 3) indicate how much of claim percentage wise is in limitations; 4) display mapped claim elements in chart that user can designate “relevant” or “not relevant,”; 5) optionally calculate relevance to a product or technology; 6) optionally keyword map the chosen claim segment and show keyword chart; 7) optionally allow user to designate relevance of keywords and optionally automatically calculate relevance to product; 8) optionally add more keyword as synonyms; and 9) use keywords, synonyms, field of invention and/or mapped segments, or other patent-related information to find related products on web sites or to find similar patents that are later issued.

In an embodiment, the technical field of a matter is issued as a claim mapping concept. The technical field may then be used as fuzzy scoring technique to score the relevancy to a technology or product.

In an embodiment, a tool is used to use keywords of a claim to rate its relevance to a product. For example, claim keywords or phrases are isolated from claims and associated with claims. Users may rate the applicability of the isolated keywords or phrases to a target technology/product. The ratings may be used to determine score of relevance of claim to technology/product. The result may be an indication of relevance, where relevance is determined by exclusion like in claim mapping.

Portfolio Analytics

In various embodiments, a tool for portfolio analytics may be used that has the following features: a. Keep cases organized by; i. List of all Individual Matters; ii. For each Matter, a list of family matters; iii. For each Matter, a list of prior art; iv. Matters can be organized into Portfolios; 1. For each portfolio, there is a “roll-up”; a. A group of matters; b. A group of prior art references (from all matters); c. A superset group of family members (from all matters) (note, all family matters may be in portfolio so in that case it would be redundant); b. Generate analytics for individual matters; i. Matter itself; ii. For family group; iv. For prior art group for the matter; c. Generate analytics for Portfolio; i. For aggregate of Matters in portfolio; ii. For aggregate of Prior Art in portfolio; iii. For aggregate of Family members for portfolio; d. Add list of competitors; i. Generate comparisons between patents owned by competitors and Matters in portfolio; 1. By technology—class/subclass/other; 2. By other groupings; e. Add list of technologies—e.g. by class/subclass or by other criterial; i. Generate comparisons based on technologies.

In an embodiment, a tool may rate importance of a US continuation by automatically determining the amount of overlap with a prior case. For example, 1) are claims longer or shorter? 2) what is the keyword overlap or uniqueness between cases? More or less keywords? 3) What are the common and unique claim limitations?

In an embodiment, a tool is used to compare issued patent claims with published claims to generate “novelty” material. Here the tool may look for words or word roots or phrases found in issued claims but not in published patent. These changes may represent the most novel portions of the claims. This can be used for various purposes. For mapping, it may be used to help identify a novelty scope concept. For just understanding patent, or potential FWE, it may show what was added to claims. One output may be patent claims showing which words were not in application claims as published. A map be generated with automated patent mapping to identify interesting material to map.

In an embodiment, a tool is used to look at abandonment rate for class/subclass or prior art family. Also, the rate of abandonment for the prior art for a case, and particular art, may be determined. In various embodiments, the tool may look at 102/x reference rate and display the rate to a user. Abandonment suggestions may be based on the same analysis.

In various embodiments, a tool is used to look at the internal versus external ratings of a patent. For example, the tool may create a rating for a patent that is based on relevance to the company's own key technologies/patents and a rating for external companies—relevance to the other companies key technologies/patents.

In an embodiment, for the internal rating for Subject Company:

1. Identify automatically or manually the best patents a company has; a. For example by company picking them; b. Or by looking at how many times patent is cited; 2. Rate any given patent of the Subject Company by its relevance to the best patents a company has, 3. Other parameters.

In an embodiment, for the external rating for the Subject Company: 1. For any given Competitor company, figure out the one or more best patents that the company has; and 2. Rate the relevance of any give patent of the Subject Company to the Competitor Company. In other words, for external ratings, the relevance of any given patent of the Subject Company (one for example you may need to pay an annuity on) to each Competitor is rated Competitors can be used picked, or determined by which companies have patents in same class/subclass or cited against Subject Patent.

In various embodiments, a tool is implemented to determine what classes/technologies a company has the best position in. This may be based on percent of a class/subclass and total number of citations. The tool may determine open areas for a company based on existing filings. For example, it may show the areas with the most promise for patenting based on a number of patents and timeline for the class (e.g., how close to the beginning of filings for a particular area).

Annuity Management

In various embodiments, a tool for annuity payment architecture has: a. Have master US patent database, and foreign patent database; b. Allow subscribers to identify their patents in this pre-populated database; and c. Set up payment option for them.

In various embodiments, a tool is used for annuity follow me tracking. For example, the tool may track owners of patents so that when it is time to pay annuity, they can be found. Features may include: a) track patent requiring annuity; b) add contact for patent—name, physical address, emails, text message address, mobile, land line; c) add second or third backup contacts—names, physical address, emails, phones, employers, social security number if possible; d) contact is pinged periodically, automatically; e) if no reply, ping goes to backups to find owner; f) lack of contact info for owner is identified early; g) This functionality may be tied to either: 1) a single patent; 2) a group of patents; h) UI—user sees list of patent(s). User can choose “follow me” service for reminders on these patents; i) reminders can come multiple ways—as noted above; j) add reminders to LinkedIn or to Facebook—social network tie-in. these are places that someone would likely stay connected to; k) connect to LinkedIn or Facebook, or other SN, and monitor if the person is present, and if the person disappears from there, flag them as “missing” to invoke follow up tracking; 1) have application in LinkedIn or Facebook that keeps track of patent maintenance fee due dates, and notifies user when due; m) have iPhone/smart phone app that keeps track of dates, they could be embedded in App not only downloaded, and generates alerts for payment—while fee may change, typically date due will not; n) create a “remind me” hierarchy—start with automated e-mail/call/text to first person on list. If they don't reply, go to the second person, and so on, till you exhaust list, trying to reach someone.

In an embodiment, a tool for Maintenance Fee Portfolio Optimizer may look at variables that can be controlled for maintenance fee payment (e.g., a service provider, exchange rate, payment date) across a number of countries and makes recommendations for savings and the estimated amount of savings.

In various embodiments, a User Interface for a Maintenance Fee Analyzer Site may be implemented. The site may: A) provides access to the Maintenance Fee database; B) User Interface Features may include: i. Look up any patent or application in database; ii. show user the annuity fee for that case; a. how user currency conversion based on two or more dates that currency would be purchased; —within a range, say default 6 months prior to payment date, show highest and lowest currency conversion quotes; b. allow user to specify “pricing date” used to price the currency conversion; iii. show user if agent fee is required; iv. show user typical annuity provider fees; v. allow user to price out a cost to pay fee; vi. Allow user to configure annuity provider charge profile—a) amount of provider fee; b) amount of currency mark-up; c) use reasonable agent fee (or none); d) estimate cost of payment, based on today's currency conversion rates; C) Allow user to “find family” for any given case they are looking at and show the family; a) a) provide maintenance fee estimates for those cases; b) b) estimate total cost of family.

In an embodiment, a tool for Credit-based Annuity Payment Processing is implemented. The features may include: a) In annuity payment system, credit score may be deemed important to getting paid; b) score the credit risk for all annuity payments made in the patent management system; c) credit scores based on owners would be pulled into system; d) credit risk may be judged by prior history of paying PTO fees or WIPO cases—abandonment of these cases would indicate poor credit; e) Using score, the tool may adjust pricing and/or flag high risk payments; f) the tool may help implement the purchase of credit-insurance for each risky payment, from an outside funding source; g) Secondarily, the tool may offer credit option for some customers based on risk, but finance the credit option with an outside funding source; h) Credit risky owners may be flagged and correlate to patent holdings, so patent purchasing agents and trolls could see who was in need of financing.

In various embodiments, a tool is used for an international patent registry architecture. The architecture may be implemented in a variety of ways such as: 1. For each country, there is a maintenance fee registry or database that is synchronized with, mirrored or is actual integrated with a country's equivalent of a PAIR/maintenance fee system. a. In one embodiment, this registry or database simply reflects the actual due dates kept on the PAIR system—i.e, the registry database does not calculate due dates, but simply reflects the due dates presented by the PAIR system. b. Similarly, the registry database also simply reflects the amounts due showing on the PAIR system, as opposed to keeping a separate database of them. 2. This registry could be one computer system/database that spans all the patent offices it serves, or be split. 3. There may be no docket maintained separate from the PAIR system—so the tool helps to eliminate the possibility of errors of keeping docket dates. (note, most if not all docket systems keep due dates for annuity payments based on a set of docket rules, not based on what is in PAIR itself) 4. Separately from the Registry database, there may be a database that keeps track of patents/apps owned by a particular company (e.g., an external database that may also keep track of due dates for annuities, separately from the PAIR system). 5. This external system may talk to the Registry database, and register with the Registry database to have the Registry make a payment on a particular patent a. the tool may allow various heterogeneous (e.g, systems from different vendors like) docket or matter management systems to register with it to pay annuities. This may be different than current architecture in that some of the patent maintenance payment providers pay only fees for customers they handle, and only pay through their own database systems. In the offered architecture, there may be a payment engine/registry that can be shared by all the vendors or patent owners to make sure payments are made on patents they tag in the database, and also various extra features can be effected through this architecture. As these registries grow to represent more and more patent offices, the principle function of annuity payment providers today may shift to simply tracking what patents a particular company owns, with the dates/costs/payment pipelines being provided by the registry.

In an embodiment, a direct pay conduit tool is used for the registry:

a. The Registry may provide a verifiable direct payment conduit.

b. I.e., a corporation could provide an account/letter of credit/other payment facility, that can be drawn down by patent office authority, and such that only patents registered for payment through the Registry can be paid using the payment facility.

6. Payment authorization options:

a. In one architecture, Registry provides the payment information to the docketing/Matter management vendor (such as CPI/CPA), and that vendor get approval from the Owner to pay the fees

b. Docketing/Matter management Vendor authorizes Registry to draw down on Owner's payment facility.

c. Registry verifies with Owner that it is ok to drawn down on the total $$, with an itemized report of what they plan on paying if desired. Owner can verify electronically, or Registry can get paper or voice approval

d. Authorization keys are provided to run system.

7. Themes of the architecture may be:

a. Distributed—

i. For any given owner, the tracking of ownership of patents done in one system.

1. routine docketing done in this system, but

2. maintenance fee docket dates are extracted from a different system.

ii. the amounts due and dates due for annuities/maintenance fees kept in another system—the patent registry.

b. Payment pipeline is different—

i. Instead of patent owners paying the docket/matter management system vendor for payment of annuities, annuities are paid through the Patent Registry.

ii. Payments are made to the registry entity, electronically orchestrated or tracked by registry.

iii. System vendor does not touch money paid to PTO, that money is routed through registry system or entity

iv. System vendor gets paid for tracking ownership of patents and registering for payment, but not for paying fee itself.

v. Payment could be made by patent owner directly to PTO through conduit provided by Registry

vi. Registry may provide an electronic exchange to pay annuities in any currency, either directly into PTO system or through a banking/financial system

In an embodiment, a tool is implemented as a Patent Office Payment Registry. Some annuity payment services may rely on keeping a proprietary database of patent information, where the annuity payment service has a client, and the client tells the annuity payment service which patent matters (patents or applications outside US) that the client wants the annuity payment service to handle for the purpose of annuity payment. As such, various different Annuity payment services may keep track of various different clients to handle payments for those clients and their matters. The tool change this paradigm. In the new paradigm, the tool may provide a single payment registry, where there is just one representation of each matter in any particular patent office like the USPTO and all the issued patents.) Customers of the registries are the patent owners or their agents.

In an embodiment, the tool functions as follows: 1. Customers of the patent registry become registered users with the registry site. 2. Registered users can tag any patent as a patent they want paid. Tagging can take place in a variety of ways: a. Pick a patent one at a time; b. Upload a list of patents; c. Search for patents that the owner is record owner of; 3. Registered users can specify payment options: a. Always pay; b. Pay only if instructed to pay; c. Pay under certain other circumstances. 4. Registered users can specify different funding mechanisms: a. Paypal; b. Credit card; c. Bank account; d. Back up payment methods; e. Apply for credit. 5. Registered users can request “forward contract” pricing for payment of fees in other currencies. 6. Registered users can get quotes for currency conversion rates on a real time basis. 7. System provides various features: a. Cost projections; b. Analytics; c. Claim maps; d. Title verification. 8. Database is secure, and all tagging can be encrypted. 9. Users can be notified if: a. Someone else tags the same patent; b. They seek to remove a tag before another entity adds one; c. A payment was not made; d. Various other situations. 10. Users can pay for “track me” feature that collects back up contact information and follows the registered user to make sure they are available to authorize payments. 11. Users can pre-pay fees, held in escrow, to make sure payments are made. 12. Patent families can be registered at one time, both US families or international families. In an embodiment, pricing for annuity payment is dynamically quoted during payment authorization process. And price locked with order to pay annuity. Card is charged later on due date or date before that.

In various embodiments, a tool is used to help eliminate the mark up for currency conversion. For example a payment infrastructure may be used that can support a more economical way to price/convert currency using forward contracts. Generally, the price of a forward contract is the cost of the currency on the day the contract is purchased, plus the cost of interest to hold the currency till it is delivered. This could be as little as 1% in interest cost, as compared to 6% to 20% mark up. The tool may work as follows: 1) track annuity payments due for an owner like a large European company with payments in US. 2) the tool may have a docket of due date for each patent. 3) at a specified date in advance of the due date, for example 3 or 6 months, the tool prices out how much it would cost to buy a forward contract of currency equal to the total amount of fees due on all patents being tracked that are coming due on that particular date, or due within a date range, like all fees due in a calendar month. In an alternate embodiment this can be done for one patent at a time. The cost of the forward contract is then apportioned to all the patents pro-rata based on the actual annuity fee, for the purpose of showing how much it will cost to pay each maintenance fee. The tool may provide the pricing infrastructure to support this transaction.

In an embodiment: 1) a European company (EC) may sign up to use the tool and; 2) the tool synchronizes/receives tracking data from the EC's annuity payment service (e.g., Computer Patent Annuities); 3) on a specified day in advance of when a batch of payments are due in the USPTO, the tool prices a forward contract for that batch of patents using forward contract rates we get from a participating bank; 4) the price of the currency is provided to annuity payment company (APC), which in turn uses it to send upcoming payment reports to it's EC with a list of annuities due and an amount for each; 5) EC instructs APC to make payments in US; 6) APC notifies system/bank on how much to send to USPTO to cover cost of payment for list of annuities to be paid; 7) bank wire transfers money to uspto account—this could be automated. In this model, EC pays bank directly for cost of annuities. Or, APC could pay bank and APC collect from annuity provider.

In an embodiment, a tool is used that uses claim tracking data for annuity management. By using detailed rejection data or composite claims the tool can gauge how close a patent is to prior art. For example the tool might see exactly what was added to claims to gain allowance.

In an embodiment, an annuity site reports on maintenance fees not paid and sets alerts for nonpayment. Alerts may be carry over when ownership changes.

In an embodiment, a tool is used for prosecution history to help make annuity decision or as rating metric. To determine value of claims, the tool may look at number of novelty or other rejections in US prosecution or in PCT or EPO search reports.

In an embodiment, a tool is used so that any payment agent could quote a forward contract amount for any patent, and owner can commit to using the forward payment in advance of forward date and the tool will track it all. Each user could either have a default forward date or pick a specific date dynamically on the day of before it. The interface may be integrated into the PTO payment system.

In various embodiments, a maintenance fee payments tool may be used. The tool may be implemented as a website and the site may show maintenance fees due for US and foreign and due dates. Users may follow certain matters and receive free cost projections. Users can get free quotes for payment from vendors. The site may use US and Inpadoc and other data. A User can get quote for owner-based group/portfolio. Users can view payment status and look up on app. The site may also feature “follow me” feature and other options to assure notice of fee due or payment of fee. Site may feature fee schedules for annuities for all countries and docket could show recovery options for lapsed patents due to nonpayment. The site may give fees for each case, due date, term remaining, sales of similar technology products, enforcement information. It may also shows family data, cost projections, measures of value. It may also mark patents that are in litigation and mark patents in the orange book.

In an embodiment, a tool is implanted as a web site hosted by a payment agent. The payment web site may be linked/integrated with USPTO payment interfaces and feature:

1. User identifies patents they want maintenance fees paid for

a. these patents would have payments due at various times

2. User provides a credit card to use to pay the maintenance fees

3. Payment web site pre-authorizes card for upcoming weeks/months payments

a. any issues, it notifies owner of card there is an issue

4. Payment web site uses card to go online at USPTO and execute payment for Patent Owner

5. Later, payment web site downloads AMEX/Visa transactions from web site (and other transaction data from AMEX/Visa) and reconciles payments automatically (or semi-automatically)

Payment interface:

1. Can be integrated with Annuity docket date system, and take information from annuity.

Market Analysis

In an embodiment, a tool is used for white space indicators for Analytics. This may indicate when an invention/patent is in a crowded space or is in a “white space”. The concept is to give the User an idea of which areas they are working in are most fertile. Also, it may help create a strategy for filing. Potential ways to indicate include: 1. For the class/subclass of the invention, how many patents are in the class/subclass (fewer is less crowded); 2. For the class/subclass, how old is the earliest patent in the class/subclass (newer is less crowded); 3. How old is the applied prior art cited against the patent? How old is unapplied art cited?; 4. What is the distribution of age of patents cited as prior art in the class/subclass (newer is less crowded); 5. Using keywords, determine how many patents each competitor has, or how many patents there are, in key technology areas; 6. Specific design: a) User creates a “Technology” to be added to a Technology list; b) For a Technology, user can do one or more of the following: i. Specify Representative Patents or Applications; ii. Specify Representative Keywords; iii. Specify Representative Classes/Subclasses; c) System uses one or more of these to calculate a parameter or graph showing if the Technology area is crowded or has white space; 7. 2nd Specific design: a) For any given patent or patent application, system uses keywords from the patent/application/claims and the classes/subclasses and other parameters like prior art, to determine if patent is crowded or open Technology area.

User Interfaces

In various embodiments, for the tools discussed herein a user interface may be used to determine which services a user may elect. For example: 1) User loads list of US patent/app cases into Portfolio manager, 2) each patent/app may have the following button options: a) sign up/select option to find foreign equivalents or US family, and load if desired. A-1) sign up for title guard—a tool monitors title changes, b) sign up for maintenance fee payment alerts—a tool monitors for either payments due and/or send an alert if payment not made, c) a tool offers to make payment if one is due—this is done with multiple payment options; d) sign up for basic citation alerts—any forward cite, e) sign up for advanced citation alert—a tool looks at forward citations of related patents like citation of an applied or unapplied prior art reference, or a forward cite of a forward cited patent, or a forward cite of a sibling patent, e-1) sign up for PTO Pair alerts, e-2) sign up to look for cites to the patent in pending apps, f) sign up for advanced metrics—a package of advanced analytics metrics, g) sign up for Internet watch for patent—set parameters to generate web hits that are related to patent, h) sign up for troll/patent trading activity alert—a tool detects how many patents in the same class/subclass or in other related group have changed owners in a time period.

Strategic Monitoring

In various embodiments, a tool is used to track ownership changes. This tool may be implemented as is a web site that shows daily list of changes in patent owners; assignments to newly formed companies; assignments to LLC's; assignments to corporations; assignments between existing companies; assignment of patents/applications older than a certain age; assignments that are anticipated could be filtered out, like: assignments of new patent applications to an existing patent holder; show interesting new assignments that may be suspicious; and assignments could be filtered by technology type/class/subclass.

In an embodiment, a tool is used for patent activity profiling. The tool may include the following features; a) build a patenting profile for a particular applicant/owner, or a type of owner, and then flag deviances from that profile; b) the profile may include foreign filing patterns, US filing patterns (e.g., does the owner typically file provisional first, then PCT, or PCT, US, etc. . . . , abandonments—e.g., what are they giving up on?; c) Show deviances from the profile, send out notifications; d) display filing profile for others to look at; e) this data would be assembled from public data.

In an embodiment, a tool is used to watch a competitor's prosecution. The tool may allow a user to set up an account on a web server/asp system that can pull in public PAIR files; Pick cases one at a time to add; Load cases for entire portfolio for owner and remove as desired; Specify owner, and have system automatically add new cases for owner; Automatically add related cases that are filed; Keep a list of suggested new cases to add based on: Locations of inventors; Patent counsel named on case; Class/subclass; Keywords; Cited art—i.e., if the case cites a patent from the user's company; PCT filings or other national stage claiming priority; Notify owner of account each time new suggested cases are added; Owner can keep or dismiss suggested accounts to watch; With respect to any PAIR file, user can: get notified each time there is a change; Get notified if case goes abandoned; If there is an office action; If prior art is filed.

In an embodiment, every time a US patent issues, or app publishes, a fan page is automatically set up on Facebook/social network. A tool may then then search for owners of patent on Facebook/linkedin, and invite them to become a fan. An app on the Fan page can quote fees for payment of annuities or other services. Patent or app status may be updated from public data. Updates could be forward cites of patent. Updates could be allowance, grant, rejection. Updates could be payment of maintenance fees.

In an embodiment, a tool may look at abandonment for competitor patents in same area respecting any particular maintenance fee decision. This may also be determined by: Class/subclass; Standard Industry Codes correlated to patents; Keywords; Semantic analysis.

In an embodiment, a tool is used for finding relevant web hits for watching patents. For a given watched patent the system may:

a. Keep a list of forward-cites

b. From the list of forward-cites, identify all the IP owners of the forward cites

c. Send watch notice each time new material is posted to the web site of an IP Owner that is relevant to the patent, based for example on keywords or a class/subclass concordance

d. Do the above for owners of the cited prior art.

In an embodiment, a tool is used for protect ownership of a patent and keep a patent in force, The tool may be implemented as website and include features of:

1. User goes to web site

2. User can pick any US (or where possible) any foreign patent/application. User can choose any one of the following automated protections

a. No assignment filed monitor:

i. Automatically check and report if no Assignment is filed for application within a given time frame

b. Assignment changed monitor:

i. Automatically check and report if Assignment is changed

c. Patent fee not paid—

i. automatically notify user if fee not paid

ii. kick in revival process if fee not paid

1. process might be notifying one or more law firms

2. process might include notifying agent for user

d.

“Troll Monitor/Metric

Owner Change Metric

This concept is to:

1. For any given patent/application

a. provide a rating/metric that indicates if ownership of related patents is changing

i. at a frequency above normal

ii. if there are any changes at all

iii. for prior art patents

iv. for forward cited patents

v. for patents in class/subclass, as compared to other classes/subclasses

b. using a list of known trolls, or suspected trolls

i. determine level of troll activity in an area

ii. report level of activity

iii. use as metric to determine potential value of patent

In an embodiment, a tool is used to determine the what classes/technologies a company has the best position in (e.g. By percent of class or subclass or by number of total cites). The tool may determine most open areas for a company based on existing filings—which areas show the most promise for patenting based on number of patents, timeline for class—e.g., how close to beginning of filings in the area.

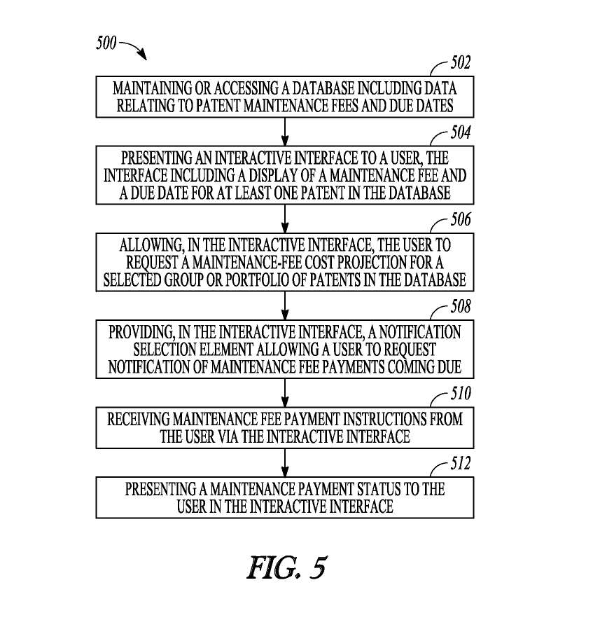

FIGS. 5-8 illustrate example methods 500, 600, 700 and 800 respectively for patent portfolio management. Some portions of these methods and others described herein may be performed by processing logic that may comprise hardware (e.g., dedicated logic, programmable logic, microcode, etc.), software (such as that which may be run on a general-purpose computer system or a dedicated machine), or a combination of both.

In one example embodiment, the processing logic resides at the analytics module 218, illustrated in FIG. 2. Some portions of the methods may be performed by the various example modules discussed above with reference to FIG. 2. Each of these modules may comprise processing logic.

As shown in FIG. 5, the method 500 commences at operation 502, maintaining or accessing a database including data relating to patent maintenance fees and due dates; at 504, presenting an interactive interface to a user, the interface including a display of a maintenance fee and a due date for at least one patent in the database; at 506, allowing, in the interactive interface, the user to request a maintenance-fee cost projection for a selected group or portfolio of patents in the database; at 508, providing, in the interactive interface, a notification selection element allowing a user to request notification of maintenance fee payments coming due; at 510, receiving maintenance fee payment instructions from the user via the interactive interface; and at 512, presenting a maintenance payment status to the user in the interactive interface.

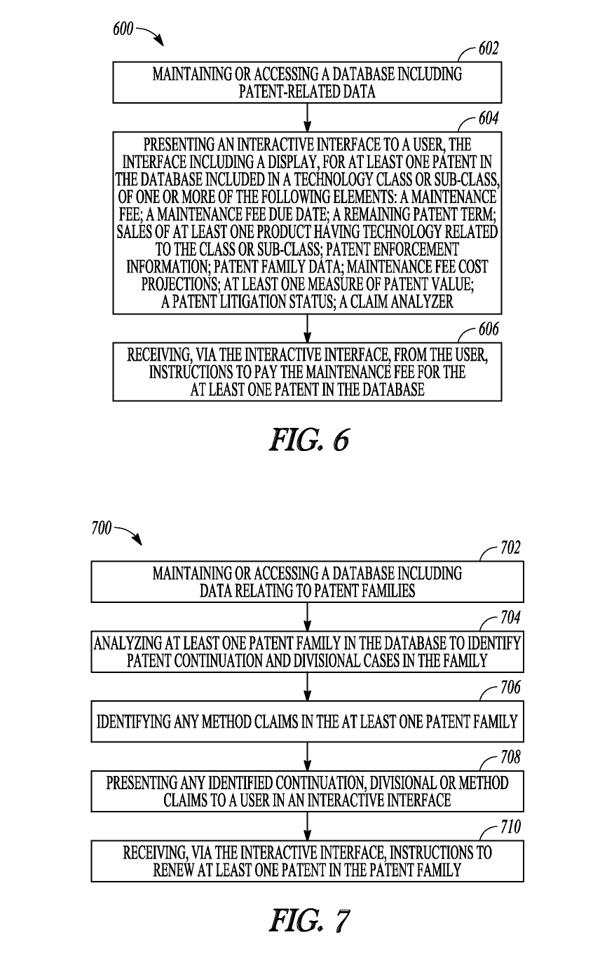

As shown in FIG. 6, the method 600 commences at operation 602, maintaining or accessing a database including patent-related data; at 604, presenting an interactive interface to a user, the interface including a display, for at least one patent in the database included in a technology class or sub-class, of one or more of the following elements: a maintenance fee; a maintenance fee due date; a remaining patent term; sales of at least one product having technology related to the class or sub-class; patent enforcement information; patent family data; maintenance fee cost projections; at least one measure of patent value; a patent litigation status; a claim analyzer; and at operation 606, receiving, via the interactive interface, from the user, instructions to pay the maintenance fee for the at least one patent in the database.

As shown in FIG. 7, the method 700 commences at operation 702, maintaining or accessing a database including data relating to patent families; at operation 704, analyzing at least one patent family in the database to identify patent continuation and divisional cases in the family; at operation 706, identifying any method claims in the at least one patent family; at operation 708, presenting any identified continuation, divisional or method claims to a user in an interactive interface; and at operation 710, receiving, via the interactive interface, instructions to renew at least one patent in the patent family.

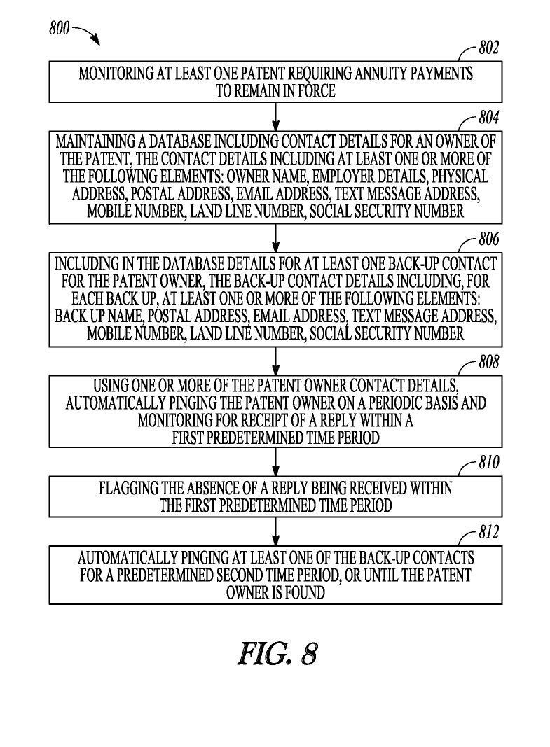

As shown in FIG. 8, the method 800 commences at operation 802, monitoring at least one patent requiring annuity payments to remain in force; at operation 804, maintaining a database including contact details for an owner of the patent, the contact details including at least one or more of the following elements: owner name, employer details, physical address, postal address, email address, text message address, mobile number, land line number, social security number; at operation 806, including in the database details for at least one back-up contact for the patent owner, the back-up contact details including, for each back up, at least one or more of the following elements: back up name, postal address, email address, text message address, mobile number, land line number, social security number; at operation 808, using one or more of the patent owner contact details, automatically pinging the patent owner on a periodic basis and monitoring for receipt of a reply within a first predetermined time period; at operation 810, flagging the absence of a reply being received within the first predetermined time period; and at operation 812, automatically pinging at least one of the back-up contacts for a predetermined second time period, or until the patent owner is found.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

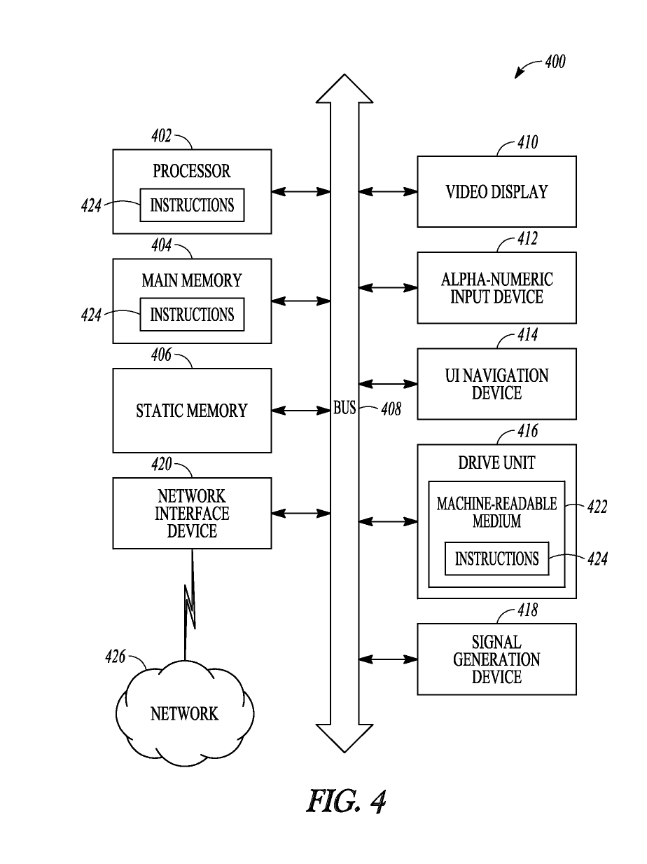

FIG. 4 is a block diagram of machine in the example form of a computer system 400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

### Machine-Readable Medium

The disk drive unit 416 includes a machine-readable medium 422 on which is stored one or more sets of instructions and data structures (e.g., software) 424 embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A computer-implemented method comprising:
providing, via a website or other communication portal, a patent monitoring tool including at least one interactive user interface;
allowing a user to identify, via the interactive user interface, a patent for automated monitoring at a patent office;
allowing a user to select, via the interactive user interface, engagement of one or more of the following automated advisory monitors for the identified patent:
a no-assignment-filed monitor, wherein the no-assignment-filed monitor is automatically to check at the patent office and report to the user if no assignment is filed against the patent at the patent office within a given time frame;
an assignment-changed monitor, wherein the assignment-changed monitor is automatically to check at the patent office and report to the user if an assignment change is recorded against the patent at the patent office; and
a patent-fee monitor, wherein the patent-fee monitor is automatically to check at the patent office and report to the user if a patent fee is not paid, and wherein the monitor is to initiate a patent revival process in the event a patent fee is not paid.

2. The computer-implemented method of claim 1, wherein the patent revival service includes an automatic notification of one or more law firms, or a patent agent selected by the user.

3. The computer-implemented method of claim 1, wherein the assignment-change monitor is further to provide a troll-detection metric that indicates if ownership of the identified patent is changing at a frequency above an identified benchmark.

4. A system comprising:
at least one module, executing on one or more computer processors, to:
provide, via a website or other communication portal, a patent monitoring tool including at least one interactive user interface;
allow a user to identify, via the interactive user interface, a patent for automated monitoring at a patent office;
allowing a user to select, via the interactive user interface, engagement of one or more of the following automated advisory monitors for the identified patent:
a no-assignment-filed monitor, wherein the no-assignment-filed monitor is automatically to check at the patent office and report to the user if no assignment is filed against the patent at the patent office within a given time frame;
an assignment-changed monitor, wherein the assignment-changed monitor is automatically to check at the patent office and report to the user if an assignment change is recorded against the patent at the patent office; and
a patent-fee monitor, wherein the patent-fee monitor is automatically to check at the patent office and report to the user if a patent fee is not paid, and wherein the monitor is to initiate a patent revival process in the event a patent fee is not paid.

5. The system of claim 4, wherein the patent revival service includes an automatic notification of one or more law firms, or a patent agent selected by the user.

6. The system of claim 4, wherein the assignment-change monitor is further to provide a troll-detection metric that indicates if ownership of the identified patent is changing at a frequency above an identified benchmark.

7. A machine readable medium, including instructions, which when performed by a machine, causes the machine to perform the operations of:
providing, via a website or other communication portal, a patent monitoring tool including at least one interactive user interface;
allowing a user to identify, via the interactive user interface, a patent for automated monitoring at a patent office;
allowing a user to select, via the interactive user interface, engagement of one or more of the following automated advisory monitors for the identified patent:
a no-assignment-filed monitor, wherein the no-assignment-filed monitor is automatically to check at the patent office and report to the user if no assignment is filed against the patent at the patent office within a given time frame;
an assignment-changed monitor, wherein the assignment-changed monitor is automatically to check at the patent office and report to the user if an assignment change is recorded against the patent at the patent office; and
a patent-fee monitor, wherein the patent-fee monitor is automatically to check at the patent office and report to the user if a patent fee is not paid, and wherein the monitor is to initiate a patent revival process in the event a patent fee is not paid.

8. The machine readable medium of claim 7, wherein the patent revival service includes an automatic notification of one or more law firms, or a patent agent selected by the user.

9. The machine readable medium of claim 7, wherein the assignment-change monitor is further to provide a troll-detection metric that indicates if ownership of the identified patent is changing at a frequency above an identified benchmark.
